(19) United States
(12) Patent Application Publication
(10) Pub. No.: US 2026/0332210 A1
(43) Pub. Date: Oct. 22, 2026

(54) TECHNIQUES FOR DYNAMICALLY TRIGGERED CSI REPORTS CARRYING TIME-DOMAIN BEAM PREDICTIONS

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Tao LUO, San Diego, CA (US)

(21) Appl. No.: 19/104,637

(22) PCT Filed: Sep. 29, 2022
(86) PCT No.: PCT/CN2022/122502

§ 371 Date: Feb. 18, 2025

(51) Int. Cl. H04B 7/06; H04W 72/0446

(52) U.S. Cl. CPC H04B 7/0626; H04B 7/06952; H04W 72/0446

(57) ABSTRACT

Techniques may support dynamically triggered channel state information (CSI) reports carrying time-domain beam predictions. A user equipment (UE) may receive, from a network entity, a first control message indicating one or more parameter sets for beam prediction via predictive CSI reporting, and a second control message requesting the UE to transmit a CSI report indicating predicted CSI measurements based on a parameter set of the one or more parameter sets. The UE may transmit, to the network entity, and in response to the second control message, the CSI report. The CSI report may indicate the predicted CSI measurements for a set of beams based on the parameter set.

### CROSS REFERENCE

This application is a 371 National Stage of PCT Application No. PCT/CN2022/122502, filed on Sep. 29, 2022, entitled “TECHNIQUES FOR DYNAMICALLY TRIGGERED CSI REPORTS CARRYING TIME-DOMAIN BEAM PREDICTIONS”, and assigned to the assignee hereof. The disclosure of the prior Application is considered part of and is incorporated by reference into this Patent Application.

### FIELD OF TECHNOLOGY

The following relates to wireless communications, including techniques for dynamically triggered channel state measurement (CSI) reports carrying time-domain beam predictions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for dynamically triggered channel state information (CSI) reports carrying time-domain beam predictions. For example, a network entity may configure a user equipment (UE) with one or more parameters for predicting CSI measurements and reporting the predicted CSI measurements in a CSI report. The network entity may transmit a control message including configurations for the UE to generate a CSI report based on beam predictions. The configuration may include a triggering state configuration, a CSI report setting, or both, for a CSI report generated based on predicted future channel characteristics. The configuration may indicate parameters for the UE to perform a beam prediction of future beams and report the predicted measurements via a CSI report. The network entity may transmit a request message (e.g., a trigger message or an activation message) to the UE, requesting the UE to transmit a CSI report with predicted measurements that are generated based on one or more configurations. The UE may transmit a report including predictive beam measurements to the network entity based on the indicated configuration. The UE may be configured to report predicted CSI measurements via an aperiodic CSI report, a periodic CSI report, or a semi-periodic CSI report. The UE may indicate UE capabilities for CSI prediction to the network entity, such as a first supported timing gap between being triggered for a predictive CSI report and transmitting the predictive CSI report or a second supported timing gap between being triggered for the predictive CSI report and a slot or time instance for generating the predicted measurements.

A method for wireless communications at a UE is described. The method may include receiving a first control message indicating one or more parameter sets for beam prediction via predictive CSI reporting, receiving a second control message requesting the UE to transmit a CSI report indicating predicted CSI measurements based on a parameter set of the one or more parameter sets, and transmitting, in response to the second control message, the CSI report indicating the predicted CSI measurements for a set of beams based on the parameter set.

An apparatus for wireless communications at a UE is described. The apparatus may include a processor, memory coupled with the processor, with instructions stored in the memory, the instructions being executable by the processor to cause the apparatus to receive a first control message indicating one or more parameter sets for beam prediction via predictive CSI reporting, receive a second control message requesting the UE to transmit a CSI report indicating predicted CSI measurements based on a parameter set of the one or more parameter sets, and transmit, in response to the second control message, the CSI report indicating the predicted CSI measurements for a set of beams based on the parameter set.

Another apparatus for wireless communications at a UE is described. The apparatus may include means for receiving a first control message indicating one or more parameter sets for beam prediction via predictive CSI reporting, means for receiving a second control message requesting the UE to transmit a CSI report indicating predicted CSI measurements based on a parameter set of the one or more parameter sets, and means for transmitting, in response to the second control message, the CSI report indicating the predicted CSI measurements for a set of beams based on the parameter set.

A non-transitory computer-readable medium storing code for wireless communications at a UE is described. The code may include instructions executable by a processor to receive a first control message indicating one or more parameter sets for beam prediction via predictive CSI reporting, receive a second control message requesting the UE to transmit a CSI report indicating predicted CSI measurements based on a parameter set of the one or more parameter sets, and transmit, in response to the second control message, the CSI report indicating the predicted CSI measurements for a set of beams based on the parameter set.

Some examples of the method, apparatuses, and non-transitory computer-readable medium described herein may further include operations, features, means, or instructions for transmitting a capability message indicating a capability of the UE for the beam prediction, where the predicted CSI measurements for the set of beams may be based on the capability message.

In some examples of the method, apparatuses, and non-transitory computer-readable medium described herein, the capability message indicates a first supported time domain gap between a first slot where the second control message may be received and a starting symbol or an ending symbol for the predicted CSI measurements, a second supported time domain gap between the first slot where the second control message may be received and a second slot where the CSI report may be transmitted, a third supported time domain gap between a first symbol where the CSI report may be transmitted and the starting symbol for the predicted CSI measurements, or any combination thereof.

In some examples of the method, apparatuses, and non-transitory computer-readable medium described herein, the capability message indicates one or more values for the first supported time domain gap, the second supported time domain gap, or the third supported time domain gap, or any combination thereof.

In some examples of the method, apparatuses, and non-transitory computer-readable medium described herein, the capability message indicates a first capability of the UE for the beam prediction based on a first quantity of measurement resources or a first quantity of reported reference signals and a second capability of the UE for the beam prediction based on a second quantity of measurement resources or a second quantity of reported reference signals.

In some examples of the method, apparatuses, and non-transitory computer-readable medium described herein, receiving the first control message may include operations, features, means, or instructions for receiving the first control message indicating, for each parameter set of the one or more parameter sets, a time gap between the second control message and a future instance or a future window for the predicted CSI measurements for the set of beams.

In some examples of the method, apparatuses, and non-transitory computer-readable medium described herein, receiving the first control message may include operations, features, means, or instructions for receiving the first control message indicating, for each parameter set of the one or more parameter sets, a time gap between the second control message and a future transmission occasion for the predicted CSI measurements for the set of beams.

In some examples of the method, apparatuses, and non-transitory computer-readable medium described herein, transmitting the CSI report may include operations, features, means, or instructions for transmitting the CSI report indicating a future instance or a future window for the predicted CSI measurements for the set of beams.

Some examples of the method, apparatuses, and non-transitory computer-readable medium described herein may further include operations, features, means, or instructions for predicting CSI measurements for the set of beams at a future time instance, during a future time window, or during a future scheduled transmission occasion associated with one or more channel measurement resources or one or more interference measurement resources.

In some examples of the method, apparatuses, and non-transitory computer-readable medium described herein, receiving the second control message may include operations, features, means, or instructions for receiving a downlink control information message triggering an aperiodic CSI report based on the parameter set, where the aperiodic CSI report may be the CSI report.

In some examples of the method, apparatuses, and non-transitory computer-readable medium described herein, receiving the second control message may include operations, features, means, or instructions for receiving a medium access control message activating a semi-persistent CSI report based on the parameter set, where the semi-persistent CSI report may be the CSI report.

In some examples of the method, apparatuses, and non-transitory computer-readable medium described herein, receiving the first control message may include operations, features, means, or instructions for receiving the first control message indicating the one or more parameter sets and a second set of parameter sets, where the one or more parameter sets may be associated with CSI prediction, and the second set of parameter sets may be associated with historic CSI measurements.

In some examples of the method, apparatuses, and non-transitory computer-readable medium described herein, receiving the second control message may include operations, features, means, or instructions for receiving the second control message based on a radio network temporary identifier associated with CSI prediction.

In some examples of the method, apparatuses, and non-transitory computer-readable medium described herein, a field of the second control message indicating the one or more parameter sets may be associated with CSI prediction.

A method for wireless communications at a network entity is described. The method may include transmitting a first control message indicating one or more parameter sets for beam prediction via predictive CSI reporting, transmitting a second control message requesting a UE to transmit a CSI report indicating predicted CSI measurements based on a parameter set of the one or more parameter sets, and receiving, in response to the second control message, the CSI report indicating the predicted CSI measurements for a set of beams based on the parameter set.

An apparatus for wireless communications at a network entity is described. The apparatus may include a processor, memory coupled with the processor, with instructions stored in the memory, the instructions being executable by the processor to cause the apparatus to transmit a first control message indicating one or more parameter sets for beam prediction via predictive CSI reporting, transmit a second control message requesting a UE to transmit a CSI report indicating predicted CSI measurements based on a parameter set of the one or more parameter sets, and receive, in response to the second control message, the CSI report indicating the predicted CSI measurements for a set of beams based on the parameter set.

Another apparatus for wireless communications at a network entity is described. The apparatus may include means for transmitting a first control message indicating one or more parameter sets for beam prediction via predictive CSI reporting, means for transmitting a second control message requesting a UE to transmit a CSI report indicating predicted CSI measurements based on a parameter set of the one or more parameter sets, and means for receiving, in response to the second control message, the CSI report indicating the predicted CSI measurements for a set of beams based on the parameter set.

A non-transitory computer-readable medium storing code for wireless communications at a network entity is described. The code may include instructions executable by a processor to transmit a first control message indicating one or more parameter sets for beam prediction via predictive CSI reporting, transmit a second control message requesting a UE to transmit a CSI report indicating predicted CSI measurements based on a parameter set of the one or more parameter sets, and receive, in response to the second control message, the CSI report indicating the predicted CSI measurements for a set of beams based on the parameter set.

Some examples of the method, apparatuses, and non-transitory computer-readable medium described herein may further include operations, features, means, or instructions for receiving a capability message indicating a capability of the UE for the beam prediction, where the predicted CSI measurements for the set of beams may be based on the capability message.

In some examples of the method, apparatuses, and non-transitory computer-readable medium described herein, the capability message indicates a first supported time domain gap between a first slot where the second control message may be transmitted and a starting symbol or an ending symbol for the predicted CSI measurements, a second supported time domain gap between the first slot where the second control message may be transmitted and a second slot where the CSI report may be received, a third supported time domain gap between a first symbol where the CSI report may be received and the starting symbol for the predicted CSI measurements, or any combination thereof.

In some examples of the method, apparatuses, and non-transitory computer-readable medium described herein, the capability message indicates one or more values for the first supported time domain gap, the second supported time domain gap, or the third supported time domain gap, or any combination thereof.

In some examples of the method, apparatuses, and non-transitory computer-readable medium described herein, the capability message indicates a first capability of the UE for the beam prediction based on a first quantity of measurement resources or a first quantity of reported reference signals and a second capability of the UE for the beam prediction based on a second quantity of measurement resources or a second quantity of reported reference signals.

In some examples of the method, apparatuses, and non-transitory computer-readable medium described herein, transmitting the first control message may include operations, features, means, or instructions for transmitting the first control message indicating, for each parameter set of the one or more parameter sets, a time gap between the second control message and a future instance or a future window for the predicted CSI measurements for the set of beams.

In some examples of the method, apparatuses, and non-transitory computer-readable medium described herein, transmitting the first control message may include operations, features, means, or instructions for transmitting the first control message indicating, for each parameter set of the one or more parameter sets, a time gap between the second control message and a future transmission occasion for the predicted CSI measurements for the set of beams.

In some examples of the method, apparatuses, and non-transitory computer-readable medium described herein, receiving the CSI report may include operations, features, means, or instructions for receiving the CSI report indicating a future instance or a future window for the predicted CSI measurements for the set of beams.

In some examples of the method, apparatuses, and non-transitory computer-readable medium described herein, the predicted CSI measurements for the set of beams correspond to a future time instance, during a future time window, or during a future scheduled transmission occasion associated with one or more channel measurement resources or one or more interference measurement resources.

In some examples of the method, apparatuses, and non-transitory computer-readable medium described herein, transmitting the second control message may include operations, features, means, or instructions for transmitting a downlink control information message triggering an aperiodic CSI report based on the parameter set, where the aperiodic CSI report may be the CSI report.

In some examples of the method, apparatuses, and non-transitory computer-readable medium described herein, transmitting the second control message may include operations, features, means, or instructions for transmitting a medium access control message activating a semi-persistent CSI report based on the parameter set, where the semi-persistent CSI report may be the CSI report.

In some examples of the method, apparatuses, and non-transitory computer-readable medium described herein, transmitting the first control message may include operations, features, means, or instructions for transmitting the first control message indicating the one or more parameter sets and a second set of parameter sets, where the one or more parameter sets may be associated with CSI prediction, and the second set of parameter sets may be associated with historic CSI measurements.

In some examples of the method, apparatuses, and non-transitory computer-readable medium described herein, transmitting the second control message may include operations, features, means, or instructions for transmitting the second control message with a radio network temporary identifier associated with CSI prediction.

In some examples of the method, apparatuses, and non-transitory computer-readable medium described herein, a field of the second control message indicating the one or more parameter sets may be associated with CSI prediction.

### BRIEF DESCRIPTION OF THE DRAWINGS

FIG. 1 illustrates an example of a wireless communications system that supports techniques for dynamically triggered channel state information (CSI) reports carrying time-domain beam predictions in accordance with one or more aspects of the present disclosure.

FIG. 2 illustrates an example of a wireless communications system that supports techniques for dynamically triggered CSI reports carrying time-domain beam predictions in accordance with one or more aspects of the present disclosure.

FIG. 3 illustrates examples of timelines that support techniques for dynamically triggered CSI reports carrying time-domain beam predictions in accordance with one or more aspects of the present disclosure.

FIG. 4 illustrates an example of a process flow diagram that supports techniques for dynamically triggered CSI reports carrying time-domain beam predictions in accordance with one or more aspects of the present disclosure.

FIGS. 5 and 6 show block diagrams of devices that support techniques for dynamically triggered CSI reports carrying time-domain beam predictions in accordance with one or more aspects of the present disclosure.

FIG. 7 shows a block diagram of a communications manager that supports techniques for dynamically triggered CSI reports carrying time-domain beam predictions in accordance with one or more aspects of the present disclosure.

FIG. 8 shows a diagram of a system including a device that supports techniques for dynamically triggered CSI reports carrying time-domain beam predictions in accordance with one or more aspects of the present disclosure.

FIGS. 9 and 10 show block diagrams of devices that support techniques for dynamically triggered CSI reports carrying time-domain beam predictions in accordance with one or more aspects of the present disclosure.

FIG. 11 shows a block diagram of a communications manager that supports techniques for dynamically triggered CSI reports carrying time-domain beam predictions in accordance with one or more aspects of the present disclosure.

FIG. 12 shows a diagram of a system including a device that supports techniques for dynamically triggered CSI reports carrying time-domain beam predictions in accordance with one or more aspects of the present disclosure.

FIGS. 13 through 16 show flowcharts illustrating methods that support techniques for dynamically triggered CSI reports carrying time-domain beam predictions in accordance with one or more aspects of the present disclosure.

### DETAILED DESCRIPTION

A wireless communications system may support machine learning-based time-domain beam prediction. Predictive beam management at a network entity may reduce overhead compared to measurement-based beam management while improving accuracy and throughput. A network entity may receive beam information from a user equipment (UE) and input the beam information into a machine learning model to output beam predictions. In some examples, the network entity may determine a confidence level for one or more beam predictions. If the beam confidence prediction for a beam prediction is too low (e.g., below a threshold), the network entity may not implement beam management based on that beam prediction. For example, the network entity may request further information to improve confidence for the beam prediction.

A wireless communications system may support techniques for dynamically triggered channel state information (CSI) reports carrying time-domain beam predictions. The network entity may transmit a control message indicating one or more configurations, or parameter sets, for generating a CSI report based on beam prediction. The control message may include a CSI triggering state configuration, a CSI report setting, or both. A configuration for generating a CSI report based on beam prediction may include parameters for predicting future beams, or predicting future channel characteristics, and reporting the predictions via a CSI report. In some examples, the network entity may transmit the control message indicating the configurations for beam prediction via a Radio Resource Control (RRC) message. The network entity may transmit another control message (e.g., a request message) to request a CSI report from the UE, and the request message may indicate one of the configurations for beam prediction.

The UE may perform CSI measurement predictions based on the indicated configuration and transmit a report including the predicted CSI measurements to the network entity. The UE may be requested to report predicted CSI measurements via an aperiodic CSI report, a periodic CSI report, or a semi-periodic CSI report. In some examples, the UE may indicate UE capabilities for CSI prediction to the network entity, such as threshold differences between transmissions (e.g., maximum or minimum time differences) or time instances for predictions. For example, the UE may indicate a minimum duration between receiving a request for a CSI report including CSI predictions and transmitting the CSI report with the CSI predictions, or a maximum duration between receiving the request for the CSI report and a time instance used to generate the CSI predictions.

Aspects of the disclosure are initially described in the context of wireless communications systems. Aspects of the disclosure are further illustrated by and described with reference to a wireless communication system, timelines, and a process flow diagram. Aspects of the disclosure are further illustrated by and described with reference to apparatus diagrams, system diagrams, and flowcharts that relate to techniques for dynamically triggered CSI reports carrying time-domain beam predictions.

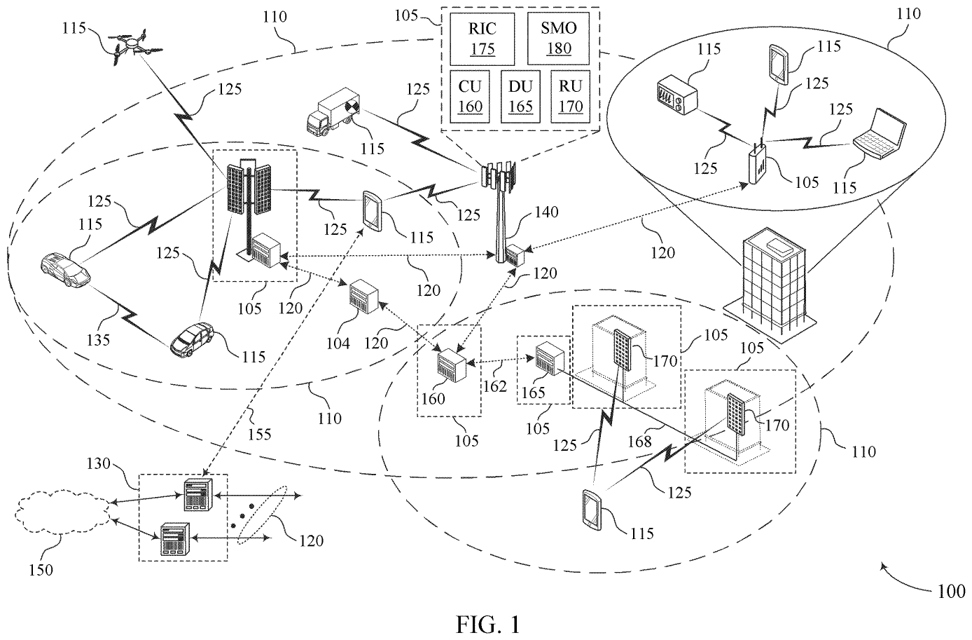

FIG. 1 illustrates an example of a wireless communications system 100 that supports techniques for dynamically triggered CSI reports carrying time-domain beam predictions in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for dynamically triggered CSI reports carrying time-domain beam predictions as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to any combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or any combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use any combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described herein with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include any combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples of the wireless communication system 100, beam management may be calculated via historic measurements (e.g., the last beam measurement). However, calculating beam qualities and failures via measurements alone may result in high power consumption or overhead. Additionally, beam accuracy may be limited if power and overhead consumption is limited. To prevent these issues, the wireless communication system 100 may implement predictive beam management using artificial intelligence (AI) or machine learning models. In some examples, predicting non-measured beam qualities may reduce power consumption and overhead, and predicting future beam blockages and failures may reduce latency and increase throughput.

In some examples, as beam predictions may be based on UEs 115 speed or trajectories, a quantity of receive beams used or to be used, interference, or other qualities, predicting the measurements may be highly non-linear. For example, as an input to the machine learning model, there may be a time series of L1-RSRPs. In some cases, the input may be based on inference from the network entity 105 which may be based on L1-RSRPs or receive beams reported by different UE(s) 115 or side information (e.g., UE 115 location information). In some other cases, the input may be based on inference from the UE 115 which may be based on L1-RSRPs measured by the UE 115, receive beams used at the UE 115, or side information (e.g., location, other UEs 115 predictions) signaled from the network entity 105 via downlink communications.

In some examples, there may be some tradeoffs for having the input be based on inference from the network entity 105 or the UE 115. For example, when predicting future downlink transmission beam qualities, the UE 115 may have more observations via measurements than the network entity 105, whose observations are determined based on feedback from the UE 115. Therefore, predictions at the UE 115 may outperform those of the network entity 105, but the UE 115 may consume more power for the inference efforts than the network entity 105. Additionally, training the machine learning model at the network entity 105 or the UE 115 may have some additional tradeoffs. For examples, training the model at the network entity 105, data may be collected via air interface or via app-layer approaches, however this may lead to additional data collections efforts which may increase power consumption or latency. However, training the model at the UE 115 may also lead to increased power consumption or latency as additional computation and buffering efforts may be required by the model training. Additionally, there may be a need for additional data storage at the UE 115. As such, while both the UE 115 and the network entity 105 may have increased power consumption or latency due to training the model, the power consumption or latency of the UE 115 or the network entity 105 may be offset by the other device being used for beam predictions. For example, in some cases the network entity 105 may train the model and the UE 115 may perform the beam predictions for the model (or vice-versa), as such, neither the network entity 105 nor the UE 115 may continually experience increased power or consumption over a given amount of time.

After being trained and receiving an input from either the network entity 105 or UE 115, the machine learning model may output various beam predictions. In some cases, the model may output predicted L1-RSRPs and a corresponding confidence level (e.g., facilitated by further RSRP mean and deviation predictions) along with predicted beam identifiers and a corresponding confidence level. The confidence levels (e.g., ranging from 0 for least confident to 1 for most confident) generated alongside the predicted outputs enable the network entity 105 and the UE 115 to determine whether a predicted beam is to be used. For example, a high confidence level (e.g., 0.9) may signal that a predicted measurement is accurate and trustworthy, whereas a low confidence level (e.g., 0.1) may signal that the predicted measurement should not be used and should be regenerated after more data has been collected to calculate the predicted measurement.

In some cases, there may be a threshold for the confidence level wherein if a prediction has a confidence level below a certain predetermined threshold (e.g., 0.5), the prediction should not be used and should be determined again with more information. In some examples, predicting the L1-RSRPs and beam identifiers may support serving beam refinement and link quality (e.g., CQI/PMI) and interference adaptation. In some other examples of the model output, the model may generate predictions on beam failure and blockage. These predictions may support generations of beam failure or blockage predictions or radio link failure predictions. In such examples, the machine learning model may benefit the UE 115 by supporting lower power consumption or lower UE 115 specific reference signal overhead compared to other statistical signal processing methods and may allow for lower latency and increased throughput.

The techniques described herein may support dynamically triggered CSI reports carrying time-domain beam predictions. The network entity 105 may configure the UE 115 with configurations for a CSI report. The configuration may include parameters for performing a dynamic beam prediction and reporting predicted measurements via a CSI report. The network entity 105 may transmit a control message indicating a configuration for beam measurements and a CSI report, and may transmit a trigger message requesting a report. The UE 115 may transmit a report including predictive beam measurements to the network entity based on the indicated configuration. The UE 115 may be configured to report predicted CSI measurements via an aperiodic CSI report, a periodic CSI report, or a semi-periodic CSI report. The UE 115 may indicate UE 15 capabilities for CSI prediction to the network entity, such as threshold differences between transmissions (e.g., maximum or minimum time differences).

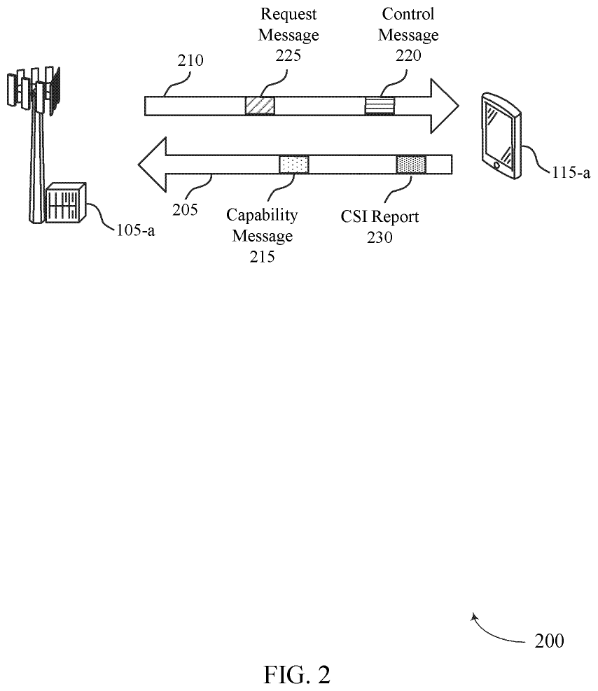

FIG. 2 illustrates an example of a wireless communications system 200 that supports techniques for dynamically triggered CSI reports carrying time-domain beam predictions in accordance with one or more aspects of the present disclosure.

Wireless communications system 200 describes the communications between a network entity 105-a, which may be an example of the network entity 105 as described herein with reference to FIG. 1, and a UE 115-a, which be an example of the UE 115 as described herein with reference to FIG. 1. The network entity 105-a and the UE 115-a may communicate various messages via a downlink 210, an uplink 205, or both.

The wireless communications system 200 may support predictive beam management and measurement-based beam management. For measurement-based beam management, the network entity 105-a or the UE 115-a, or both, may select beams based on measurements of channel conditions. For predictive beam management, the network entity 105-a or the UE 115-a, or both, may perform predictions on future beams or channel characteristics, and the network entity 105-a and the UE 115-a may communicate using beams based on the predictions. Predictive beam management may reduce power consumption and resource overhead for beam management. In some examples, a beam prediction may have a corresponding confidence level. For example, if the beam prediction has sufficient data to make a reliable prediction, the beam prediction may have a high confidence level. If a beam measurement has a low confidence level, the network entity 105-a may not perform beam management based on the beam measurement with the low confidence level.

The wireless communications system 200 may support techniques to provide additional information for predictive beam management based on UE-side predictions. For example, the network entity 105-a may configure the UE 115-a with parameter sets (e.g., configurations) to perform CSI measurement predictions. The network entity 105-a may request the UE 115-a to transmit a CSI report and indicate one of the configurations for CSI measurement predictions with the request. The network entity 105-a may receive the CSI report with CSI measurement predictions and may supplement network-side beam predictions with the additional information or otherwise may implement beam management based on the CSI measurement predictions from the UE 115-a.

For example, the network entity 105-a may request for the UE to report historically measured or predicted future beams in a CSI report. The network entity 105-a may transmit a control message 220 indicating configurations for the UE 115-a to perform CSI measurement predictions or beam predictions and report the predictions in a CSI report 230. The UE 115-a may determine whether report quantities associated with the CSI report 230 relate to historic measurements or predicted future channel characteristics. The UE 115-a may determine whether the report quantities are for historic measurements or predictions based on signaling from the network entity 105-a, such as the control message 220 to configure the CSI reporting configuration or a request message 225 to trigger or activate the CSI report 230. In some examples, the report quantities of the CSI report 230 may include a Layer 1 (L1) reference signal received power (RSRP), L1 signal-to-interference plus noise ratio (SINR), a rank indicator (RI), a precoding matrix indicator (PMI), layer indicator (LI), channel quality indicator (CQI), CSI-RS resource indicator (CRI), synchronization signal block indicator (SSBI), beam blockage, or any combination thereof.

Historic measurements may be associated with channel measurement resources (CMRs) or interference measurement resources (IMRs) corresponding to the CSI report 230, or both CMRs and IMRs. Predicted future channel characteristics may also be associated with the CMRs or IMRs corresponding to the CSI report 230, or both CMRs and IMRs, but the predicted future channel characteristics may be determined for time instances or resource occasions which have not occurred by the time the UE 115-a generates the predictions. If the CSI report 230 includes measurement predictions, the report quantities may include a confidence level for the measurement predictions.

In some examples, the network entity 105-a may indicate future time instances or windows, and the UE 115-a may predict channel characteristics for the indicated future time instances or windows. For example, if the report quantities for the CSI report 230 correspond to predicted future channel characteristics, a configuration for the CSI report 230 may indicate the future time instances or windows for the predictions. In some examples, the control message 220 indicating the parameter sets or configurations may indicate the future time occasions or windows, or the request message 225 may indicate the future time occasions or windows. In some examples, the UE 115-a may perform the predictions for a time instance later than, or offset from, the time instance when the request message 225 is received. For example, the time instance for the prediction may be offset by a quantity of milliseconds, slots, or subframes from the request message 225. In some examples, the control message 220 may include the time offset for the UE 115-a to identify the time instance. In some examples, the time instance may be offset from a slot for transmitting the CSI report 230. For example, the UE 115-a may apply the configured time offset to a slot allocated for the CSI report to identify the time instance for determining the CSI measurement predictions.

In some examples, the UE 115-a may perform the predictions for a future time window. For example, the future time window may have a starting point which is offset from the request message 225 by a quantity of time (e.g., milliseconds), symbols, slots, subframes, or may have a starting point offset from the CSI report 230 by the quantity of time. In some cases, the control message 220 may indicate the time offset or a duration for the window to generate the CSI measurement predictions, or both a time offset and duration, for a CSI report configuration associated with predictive measurements. In some examples, the UE 115-a may perform the predictions for one or more specific future transmission occasions. For example, the UE 115-a may not have yet received signaling via the future transmission occasions when the UE 115-a transmits the CSI report 230 including predictive measurements of the CMR/IMR associated with the CSI report 230. In some examples, the UE 115-a may select the time instance or time window for generating the measurement predictions, and the UE 115-a may indicate the time instance or window used to generate the predictions in the CSI report 230.

In some examples, the CSI report 230 may be an aperiodic CSI report, and the UE 115-a may be triggered to transmit the CSI report 230 including the CSI measurement predictions. The network entity 105-a may transmit one or more control signals indicating one or more control information elements to configure parameters for predictive CSI reporting or to trigger an aperiodic CSI report associated with measurement predictions. For example, the network entity 105-a may transmit the control message 220 indicating one or more parameters for one or more CSI report settings. In some cases, each CSI report setting may include a flag (e.g., a predict flag), which indicates whether the CSI report setting is associated with historical measurements or predicted measurements. In some examples, the predict flag for a CSI report setting may be configured to be associated with predicted measurements, and the CSI report setting may include additional parameters for the future time instance for the predicted measurements (e.g., a window or time instance associated with the predictions).

In some examples, the control message 220 may indicate parameters for an aperiodic triggering state configuration associated with a corresponding CSI report setting and predictive CSI measurements reported via an aperiodic CSI report. In some examples, the aperiodic triggering state configuration may include information for the future time instance or window for the CSI measurement predictions or additional parameters for the UE 115-a to use to generate the CSI measurement predictions.

If the CSI report 230 is an aperiodic CSI report, the aperiodic CSI report associated with the aperiodic triggering state may triggered via DCI. A parameter (e.g., CSI-AssociatedReportConfigInfo) indicated by the DCI may include a flag set to indicate that the aperiodic CSI report is associated with CSI measurement prediction, and the parameter may include information (e.g., indicate parameters) associated with the future time instance for the CSI measurement prediction.

In some examples, the network entity 105-a may trigger an aperiodic CSI report for CSI measurement prediction using a mixed indication. For example, the CSI report setting included in the control message 220 may include part of the parameters for an aperiodic CSI measurement prediction, while the aperiodic triggering state configuration associated with the CSI report 230 setting may include another part of the parameters for the aperiodic CSI measurement prediction. For example, the CSI report setting may indicate whether the report quantities are regarding historical measurements or predicted future channel characteristics (e.g., through a flag in the information element of the CSI report setting). The aperiodic triggering state configuration may indicate more details regarding the time instance for the CSI measurement prediction. If the flag in the CSI report corresponds to predictive measurements, the information for the future time instance may be included in one or more indications, fields, parameters, or information elements (e.g., a CSI-AssociatedReportConfigInfo field, which may be included as part of a CSI-Aperiodic TriggerState field, which may be included as a part of a CSI-Aperiodic TriggerStateList field).

In some examples, the network entity 105-a may trigger the aperiodic CSI report for CSI measurement predictions via DCI with a separate aperiodic CSI triggering state list. In some cases, the separate aperiodic CSI triggering state list may be dedicated for, or specific to, CSI measurements for beam predictions. The CSI triggering state list associated with aperiodic CSI reports with report quantities based on predicted future channel characteristics may be configured separately from a CSI triggering state list for historical measurements. For example, the DCI may include a first CSI triggering state list associated with historical measurements or a second CSI triggering state list associated with beam predictions, or both. In some examples, DCI including the CSI triggering state list for beam predictions may be formatted in accordance with a DCI format based on beam prediction. In some examples, the DCI with the CSI trigger state list for beam predictions may include an RNTI based on beam predictions. In some cases, the DCI may include CSI request fields specific to beam prediction to indicate the CSI trigger state list for aperiodic beam predictions. In some examples, the CSI request fields may include a field for aperiodic triggering (e.g., CSI-Aperiodic Trigger StateList-Beam Prediction). The request message 225, or the DCI triggering of predictive aperiodic CSI reports (e.g., CSI-Aperiodic Trigger StateList), may be based on the DCI format or RNTI, or a CSI request field included as part of the DCI and dedicated to the separate aperiodic CSI triggering state list.

In some examples, the UE 115-a may transmit a capability message 215 to the network entity 105-a based on the CSI measurement predictions. For example, the capability message 215 may include information indicative of one or more capabilities of the UE 115-a for performing a CSI measurement prediction. In some examples, the capability message may indicate timeline capabilities, or requirements, for the UE 115-a to perform the CSI measurement predictions.

In some cases, the UE 115-a may be configured to report CSI measurement predictions via a periodic or semi-periodic (e.g., semi-persistent) CSI report. For example, the UE 115-a may be configured with parameter sets for a periodic CSI report setting or a semi-periodic CSI report setting to transmit a periodic CSI report or a semi-periodic CSI report including CSI measurement predictions. In some examples, for a semi-periodic CSI report, the request message 225 may be an activation message, such as a MAC message or a MAC control element. The activation message may similarly indicate one or more CSI report settings associated with beam prediction and indicate parameters for the UE 115-a to perform and report the CSI measurement predictions via the semi-periodic CSI report.

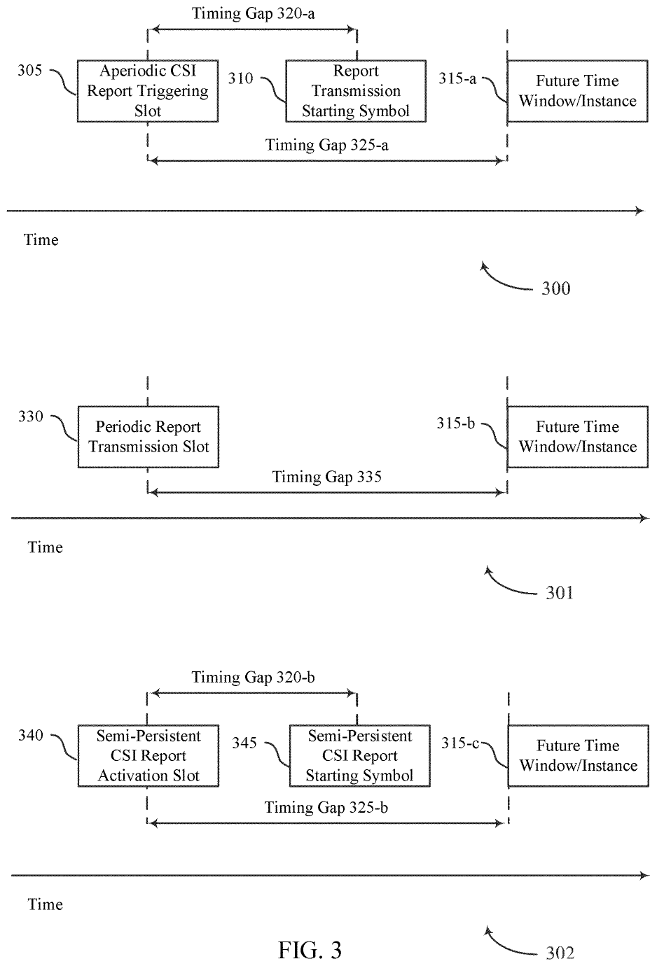

FIG. 3 illustrates an example of a timeline 300, a timeline 301, and a timeline 302 that support techniques for dynamically triggered CSI reports carrying time-domain beam predictions in accordance with one or more aspects of the present disclosure. The timeline 300, the timeline 301, and the timeline 302 may correspond to timelines capabilities of a UE 115 for beam reporting via an aperiodic CSI report, a semi-persistent CSI report, or a periodic CSI report, respectively.

The timeline 300 corresponds to a dynamically triggered CSI report carrying time-domain beam predictions in accordance with one or more aspects of the present disclosure. The timeline 300 shows different timing gaps for aperiodic predictive CSI reports from a UE 115 based on a capability of the UE 115. The UE 115 may report the timeline capability as part of a capability message as described herein with reference to FIG. 2. The capability may relate to CSI parameter indications signaled by the network entity 105 via a control message. For example, the network entity 105 may configure a CSI report setting or associated information for a CSI report configuration based on the capability information of the UE 115.

The capability may include a first capability and a second capability, corresponding to different timing gaps or durations between different signaling or measurements for the aperiodic CSI report. Based on the capabilities of the UE 115, the network entity 105 may configure timing gaps for the aperiodic CSI report for time-domain beam prediction. For example, the network entity 105 may configure a timing gap 320-a based on the first capability and a timing gap 325-a based on the second capability. The timing gaps may correspond to threshold differences in time between stages of the UE being triggered for, generating, and reporting the aperiodic CSI report, such as between a slot 305 where the aperiodic CSI report is triggered, a report transmission starting symbol 310, and a future time instance 315-a.

The timing gap 320-a may correspond to a threshold difference (e.g., minimum difference) in time between a slot 305 of the aperiodic CSI trigger, or a first symbol of the slot 305, and a starting symbol of a slot where the aperiodic CSI report carrying predicted measurements is transmitted. For example, the UE 115 may report a first capability indicating a minimum distance between a symbol where the aperiodic CSI report is triggered and a starting symbol of where the aperiodic CSI report is transmitted. The UE 115 may generate predictions and package the predictions into the aperiodic CSI report between being triggered for the aperiodic CSI report and transmitting the aperiodic CSI report. The UE 115 may transmit information indicating the first capability to indicate the minimum amount of time for the UE 115 to prepare the aperiodic CSI report with the predicted measurements.

The network entity 105 may schedule the UE 115 for aperiodic CSI reports for time-domain beam prediction based on the capability. For example, when the network entity 105 triggers an aperiodic CSI report for time-domain beam prediction at the UE 115, the network entity may schedule the aperiodic CSI report with at least the minimum time gap between the symbol where the aperiodic CSI report is triggered and a starting symbol where the aperiodic CSI report is transmitted.

The timing gap 325-a may correspond to a threshold difference (e.g., a maximum difference) between the slot where the aperiodic CSI report is triggered and the future time instance 315-a that is signaled by the network entity 105. In some examples, the timing gap 325-a may be based on the starting or ending time-domain point of a future time-domain window that is signaled by the network entity 105. In some examples, the timing gap 325-a may be based on a slot where the aperiodic CSI report is transmitted (e.g., in addition to, or alternative to, the slot where the aperiodic CSI report is triggered).

The UE 115 may perform predictions for the future time instance 315-a, but the quality of prediction for the future time instance 315-a may be based on how far in the future the future time instance 315-a is. For example, the UE 115 may be capable of generating higher quality predictions for time instances that are closer to when the UE 115 generates the predictions. If the predictions are too far in the future, the UE 115 may be unable to generate reliable predictions. Therefore, the UE 115 may indicate the second capability to limit a range (e.g., in time) for the predictions. When the network entity 105 schedules or configures the UE 115 for an aperiodic CSI for time-domain beam predictions, the network entity 105 may configure the aperiodic CSI in accordance with the second capability. For example, the UE 115 may be scheduled to perform predictions with a maximum difference of time between where the aperiodic CSI report is triggered (or where the aperiodic CSI report is transmitted) and the future time instance. In some examples, the UE 115 may not expect to be configured with an aperiodic CSI scheduling timeline which exceeds the capabilities indicated by the UE 115.

The UE 115 may report multiple pairs of combinations of the first capability and the second capability. For example, the UE 115 may indicate a first set of capability parameters including a shorter duration for the first capability and a longer duration for the second capability and a second set of capability parameters including a longer duration for the first capability and a shorter duration for the second capability. In some examples, timeline capability may be preconfigured, such as being preconfigured or predefined for a wireless communications system including the UE 115, and the UE 115 may be configured with CSI report settings in accordance with the predefined timeline capabilities.

In some examples, the UE may report capabilities based on a quantity of resources associated with a CSI report. For example, the UE may report different capabilities for different quantities of CMRs/IMRs associated with a CSI report or based on a quantity of SSBRIs/CRIs to be addressed in the CSI report. For example, the UE 115 may indicate a capability to support predicting up to a threshold of time after the aperiodic CSI trigger (or the slot carrying the aperiodic CSI report)based on the quantity of CMRs associated with the CSI report. For example, if the total number of CMRs is smaller (e.g., 4, 8), the threshold may be a longer time (e.g., 200 ms). In another example, if a total quantity of CMRs is larger (e.g., 64), the threshold may be a comparatively shorter time (e.g., 40 ms). Similarly, the UE may report different capabilities or thresholds for different quantities of reported reference signals. For example, if a quantity of reported reference signals associated with a CSI report is 4, the UE may support predicting up to 200 ms later than the trigger for the aperiodic CSI report. If a quantity of reported reference signals associated with a CSI report is 64, the UE may support predicting up to 40 ms later than the trigger for the aperiodic CSI report. In some cases, such as if the UE 115 is preconfigured with capabilities for predictive CSI reporting or thresholds for predictive CSI reporting, timelines for predictive CSI reporting may similarly be based on a quantity of CMRs or IMRs associated with a CSI report or a quantity of reported reference signals associated with the CSI report, or both.

The timeline 301 corresponds to a periodic CSI report carrying time-domain beam predictions in accordance with one or more aspects of the present disclosure. In some examples, a network entity 105 may configure a UE 115 to transmit periodic CSI reports including measurement predictions in accordance with the timeline 301 based on reported capabilities of the UE.

The timing gap 335 may correspond to a time between a slot 330 where the periodic CSI report is transmitted, or a first symbol of the slot 330, and the beginning of the future time instance 315-b. The future time instance may be defined based on the timing gap 335. For example, the future time instance 315-b, or the time instance for which the UE 115 predicts CSI measurements, may be configured or defined based on a time difference between a slot 330 where the periodic CSI report is transmitted and a slot where the future time instance 315-b is captured or where the future time instance 315-b starts.

The UE 115 may report a capability indicating a time domain difference threshold (e.g., a maximum time domain difference) for the timing gap 335. For example, the UE 115 may support generating CSI predictions for time instances that are separated in time from the slot 330 by up to the indicated time domain difference threshold.

Similar to techniques described herein for an aperiodic CSI report, the network entity 105 may configure the UE 115 with one or more parameters for predictive periodic CSI reporting (e.g., via a CSI report setting) via an RRC message or an RRC configuration. For example, the network entity 105 may transmit an RRC message to configure the UE 115 with parameters for periodic CSI reporting for time-domain beam prediction. The network entity 105 may configure one or more CSI report settings for a period CSI report associated with beam prediction.

The timeline 302 corresponds to a semi-persistent CSI report carrying time-domain beam predictions in accordance with one or more aspects of the present disclosure. In some examples, a network entity 105 may configure a UE 115 to transmit semi-persistent CSI reports including measurement predictions in accordance with the timeline 301 based on reported capabilities of the UE.

The timing gap 320-b may correspond to a time difference between a slot 340, or first symbol of the slot 340, where the semi-persistent CSI report is activated and a slot 340, or first symbol of the slot 345, where the predictive semi-persistent CSI report including the predicted CSI measurements is transmitted.

The timing gap 325-b may be based on the time difference between the slot 340 where the activation message is received and the slot where the future time instance 315-c is captured or starts. In some examples, the future time instance 315-c for a semi-persistent CSI report for time-domain beam prediction may be configured or defined based on the timing gap 325-b.

The UE 115 may report threshold values for the timing gap 320-b and the timing gap 325-b, such as a minimum value and a maximum value, respectively. The network entity 105 may transmit control signaling to configure one or more CSI report settings for a semi-persistent CSI report for CSI measurement predictions based on the capability of the UE, where the timing gaps for the one or more CSI reports are within the indicated threshold capabilities of the UE.

For example, the network entity 105 may configure parameters for a semi-persistent CSI report for beam prediction via one or more CSI report settings via an activation message (e.g., a MAC control element) activating the semi-persistent CSI report. In some examples, the CSI report may be based on a mixed indication by joint parameters from the CSI report setting and the activation message. For example, the CSI report setting may indicate whether the report quantities are regarding historical measurements or predicted future channel characteristics (e.g., through a flag of the information element of the CSI report setting). A semi-persistent CSI-report activation MAC-CE may indicate additional parameters or information regarding the future time instance 315-c.

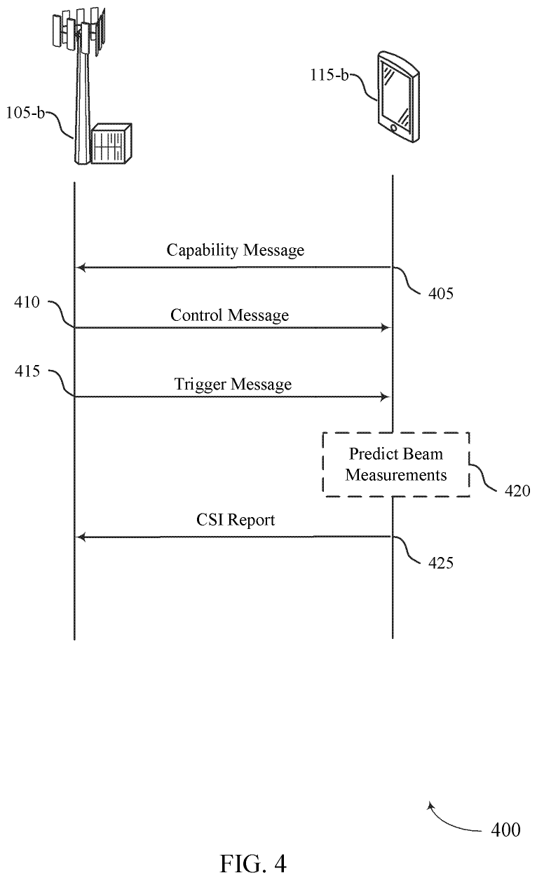

FIG. 4 illustrates an example of a process flow 400 that supports techniques for dynamically triggered CSI reports carrying time-domain beam predictions in accordance with one or more aspects of the present disclosure. The process flow 400 describes communications between a network entity 105-b and a UE 115-b, which may be respective examples of a network entity 105 and a UE 115 as described herein with reference to FIG. 1.

At 405, the UE 115-b may transmit a capability message to the network entity 105-b. The capability message may indicate a capability of the UE 115-b for beam prediction, where the predicted CSI measurements for the set of beams are based on the capability message.

In some examples, the capability message may indicate one or more time gaps supported by the UE 115-b. For example, the capability message may indicate a first supported time domain gap between a first slot where a second control message (e.g., a CSI request which triggers an aperiodic CSI report or activates a semi-persistent CSI report) is received and a starting symbol or an ending symbol for predicted CSI measurements. Additionally, or alternatively, the capability message may indicate a second supported time domain gap between the first slot where the second control message is received and a second slot where a CSI report is transmitted. Additionally, or alternatively, the capability message may indicate a third supported time domain gap between a first symbol where the CSI report is transmitted and the starting symbol for the predicted CSI measurements.

For example, the capability message may indicate one or more values for the first supported time domain gap and one or more values for the second time domain gap with respect to an aperiodic CSI report for time-domain beam prediction. Additionally, or alternatively, the capability message may indicate one or more values for the third time domain gap with respect to a periodic CSI report. Additionally, or alternatively, the capability message may indicate one or more values for the first supported time domain gap and one or more values for the second supported time domain gap with respect to a semi-persistent CSI report.

In some examples, the capability message may indicate one or more values for the first supported time domain gap, the second supported time domain gap, the third supported time domain gap, or any combination thereof. The capability message may indicate a first capability of the UE 115-b for the beam prediction based on a first quantity of measurement resources or a first quantity of reported reference signals, and may indicate a second capability of the UE 115-b for the beam prediction based on a second quantity of measurement resources or a second quantity of reported reference signals. For example, the UE 115-b may support different durations for the first time domain gap, the second time domain gap, or the third time domain gap based on a quantity of measurement resources or a quantity of reported reference signals for a CSI report.

At 410, the network entity 105-b may transmit a first control message to the UE 115-b. The first control message may be based on the capability message or the capability of the UE 115-b. The first control message may indicate one or more parameter sets for beam prediction via predictive CSI reporting. For example, the first control message may configure one or more CSI report settings at the UE 115-b for a CSI report which is used to convey predicted CSI measurements. In some examples, the first control message may configure a CSI report setting for one or more aperiodic CSI reports, periodic CSI reports, semi-persistent CSI reports, or any combination thereof.

In some examples, the control message may indicate, for each parameter set of the one or more parameter sets, a time gap between the second control message and a future instance or a future window for the predicted CSI measurements for the set of beams. For example, the control message may indicate, for each parameter set of the one or more parameter sets, a time gap between the second control message and a future transmission occasion for the predicted CSI measurements for the set of beams. In some examples, the first control message may indicate the one or more parameter sets and a second set of parameter sets, where the one or more parameter sets are associated with CSI prediction, and the second set of parameter sets are associated with historic CSI measurements.

At 415, the network entity 105-b may transmit a trigger message to the UE 115-b. The trigger message, which may be a second control message, may trigger the UE 115-b to transmit a CSI report at 420. The trigger message, or second control message, may request the UE 115-b to transmit a CSI report indicating predicted CSI measurements based on a parameter set of the one or more parameter sets.

The trigger message may be a DCI message triggering an aperiodic CSI report based on the parameter set, where the aperiodic CSI report is the CSI report. In some examples, the trigger message may be a MAC message activating a semi-persistent CSI report based on the parameter set, where the semi-persistent CSI report is the CSI report.

The UE 115-b may receive the trigger message, (e.g., the second control message) based on an RNTI associated with CSI prediction. A field of the second control message may indicate the one or more parameter sets associated with CSI prediction.

At 420, the UE 115-b may predict beam measurements based on the control message and trigger message. The UE 115-b may predict CSI measurements for the set of beams at a future time instance, during a future time window, or during a future scheduled transmission occasion associated with one or more channel measurement resources or one or more interference measurement resources.

At 425, the UE 115-b may transmit the CSI report to the network entity 105-a. The UE 115-b may transmit the CSI report in response to the trigger message (e.g., the second control message), indicating the predicted CSI measurements for a set of beams based on the parameter set. The CSI report may indicate a future instance or a future window for the predicted CSI measurements for the set of beams.

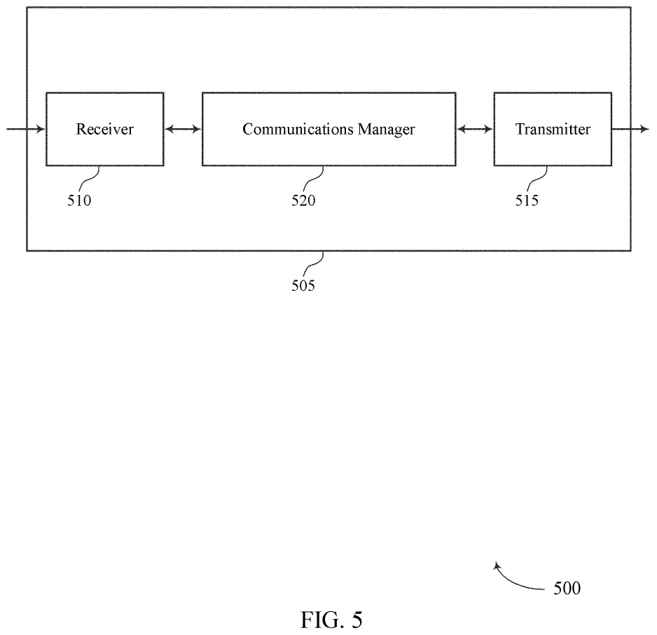

FIG. 5 shows a block diagram 500 of a device 505 that supports techniques for dynamically triggered CSI reports carrying time-domain beam predictions in accordance with one or more aspects of the present disclosure. The device 505 may be an example of aspects of a UE 115 as described herein. The device 505 may include a receiver 510, a transmitter 515, and a communications manager 520. The device 505 may also include a processor (not shown). Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for dynamically triggered CSI reports carrying time-domain beam predictions). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for dynamically triggered CSI reports carrying time-domain beam predictions). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of techniques for dynamically triggered CSI reports carrying time-domain beam predictions as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. For example, the communications manager 520 may be configured as or otherwise support a means for receiving a first control message indicating one or more parameter sets for beam prediction via predictive CSI reporting. The communications manager 520 may be configured as or otherwise support a means for receiving a second control message requesting the UE to transmit a CSI report indicating predicted CSI measurements based on a parameter set of the one or more parameter sets. The communications manager 520 may be configured as or otherwise support a means for transmitting, in response to the second control message, the CSI report indicating the predicted CSI measurements for a set of beams based on the parameter set.

By including or configuring the communications manager 520 in accordance with examples as described herein, the device 505 (e.g., a processor controlling or otherwise coupled with the receiver 510, the transmitter 515, the communications manager 520, or any combination thereof) may support techniques for dynamically triggered CSI reports carrying time-domain beam predictions, which may improve reliability for beam prediction and beam management which is based on beam prediction. For example, if a network-side beam prediction has a low confidence level, these techniques may support dynamically triggering a UE to provide additional measurement predictions via a CSI report, which may improve confidence of prediction-based beam management at the network. Prediction-based beam management may use less resource overhead and power consumption compared to measurement-based beam management, as well as reducing latency and improving throughput by predicting future beam blockages or failures. Therefore, by increasing reliability or confidence in beam management based on beam predictions, the device 505 may experience reduced resource overhead and power consumption as well as reduced latency and improved throughput .

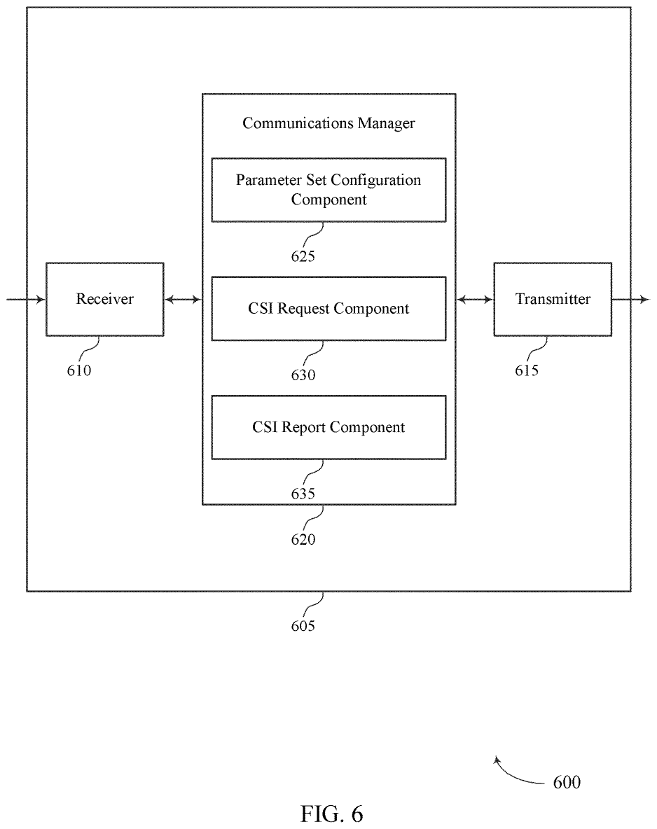

FIG. 6 shows a block diagram 600 of a device 605 that supports techniques for dynamically triggered CSI reports carrying time-domain beam predictions in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor (not shown). Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for dynamically triggered CSI reports carrying time-domain beam predictions). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for dynamically triggered CSI reports carrying time-domain beam predictions). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for dynamically triggered CSI reports carrying time-domain beam predictions as described herein. For example, the communications manager 620 may include a parameter set configuration component 625, a CSI request component 630, a CSI report component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. The parameter set configuration component 625 may be configured as or otherwise support a means for receiving a first control message indicating one or more parameter sets for beam prediction via predictive CSI reporting. The CSI request component 630 may be configured as or otherwise support a means for receiving a second control message requesting the UE to transmit a CSI report indicating predicted CSI measurements based on a parameter set of the one or more parameter sets. The CSI report component 635 may be configured as or otherwise support a means for transmitting, in response to the second control message, the CSI report indicating the predicted CSI measurements for a set of beams based on the parameter set.

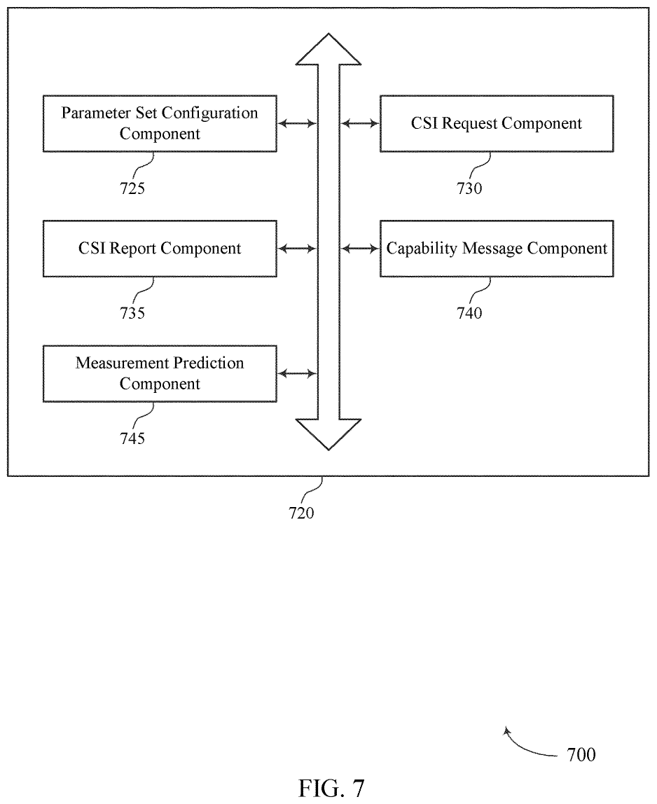

FIG. 7 shows a block diagram 700 of a communications manager 720 that supports techniques for dynamically triggered CSI reports carrying time-domain beam predictions in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for dynamically triggered CSI reports carrying time-domain beam predictions as described herein. For example, the communications manager 720 may include a parameter set configuration component 725, a CSI request component 730, a CSI report component 735, a capability message component 740, a measurement prediction component 745, or any combination thereof. Each of these components may communicate, directly or indirectly, with one another (e.g., via one or more buses).

The communications manager 720 may support wireless communications at a UE in accordance with examples as disclosed herein. The parameter set configuration component 725 may be configured as or otherwise support a means for receiving a first control message indicating one or more parameter sets for beam prediction via predictive CSI reporting. The CSI request component 730 may be configured as or otherwise support a means for receiving a second control message requesting the UE to transmit a CSI report indicating predicted CSI measurements based on a parameter set of the one or more parameter sets. The CSI report component 735 may be configured as or otherwise support a means for transmitting, in response to the second control message, the CSI report indicating the predicted CSI measurements for a set of beams based on the parameter set.

In some examples, the capability message component 740 may be configured as or otherwise support a means for transmitting a capability message indicating a capability of the UE for the beam prediction, where the predicted CSI measurements for the set of beams are based on the capability message.

In some examples, the capability message indicates a first supported time domain gap between a first slot where the second control message is received and a starting symbol or an ending symbol for the predicted CSI measurements, a second supported time domain gap between the first slot where the second control message is received and a second slot where the CSI report is transmitted, a third supported time domain gap between a first symbol where the CSI report is transmitted and the starting symbol for the predicted CSI measurements, or any combination thereof.

In some examples, the capability message indicates one or more values for the first supported time domain gap, the second supported time domain gap, or the third supported time domain gap, or any combination thereof.

In some examples, the capability message indicates a first capability of the UE for the beam prediction based on a first quantity of measurement resources or a first quantity of reported reference signals and a second capability of the UE for the beam prediction based on a second quantity of measurement resources or a second quantity of reported reference signals.

In some examples, to support receiving the first control message, the parameter set configuration component 725 may be configured as or otherwise support a means for receiving the first control message indicating, for each parameter set of the one or more parameter sets, a time gap between the second control message and a future instance or a future window for the predicted CSI measurements for the set of beams.

In some examples, to support receiving the first control message, the parameter set configuration component 725 may be configured as or otherwise support a means for receiving the first control message indicating, for each parameter set of the one or more parameter sets, a time gap between the second control message and a future transmission occasion for the predicted CSI measurements for the set of beams.

In some examples, to support transmitting the CSI report, the CSI report component 735 may be configured as or otherwise support a means for transmitting the CSI report indicating a future instance or a future window for the predicted CSI measurements for the set of beams.

In some examples, the measurement prediction component 745 may be configured as or otherwise support a means for predicting CSI measurements for the set of beams at a future time instance, during a future time window, or during a future scheduled transmission occasion associated with one or more channel measurement resources or one or more interference measurement resources.

In some examples, to support receiving the second control message, the CSI request component 730 may be configured as or otherwise support a means for receiving a DCI message triggering an aperiodic CSI report based on the parameter set, where the aperiodic CSI report is the CSI report.

In some examples, to support receiving the second control message, the CSI request component 730 may be configured as or otherwise support a means for receiving a medium access control message activating a semi-persistent CSI report based on the parameter set, where the semi-persistent CSI report is the CSI report.

In some examples, to support receiving the first control message, the parameter set configuration component 725 may be configured as or otherwise support a means for receiving the first control message indicating the one or more parameter sets and a second set of parameter sets, where the one or more parameter sets are associated with CSI prediction, and the second set of parameter sets are associated with historic CSI measurements.

In some examples, to support receiving the second control message, the CSI request component 730 may be configured as or otherwise support a means for receiving the second control message based on a radio network temporary identifier associated with CSI prediction.

In some examples, a field of the second control message indicating the one or more parameter sets is associated with CSI prediction.

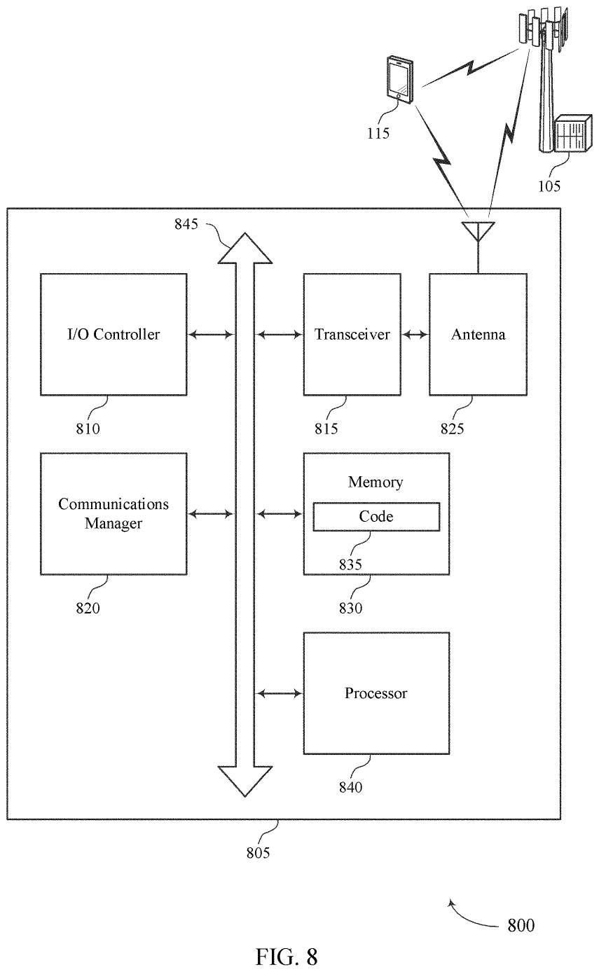

FIG. 8 shows a diagram of a system 800 including a device 805 that supports techniques for dynamically triggered CSI reports carrying time-domain beam predictions in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting techniques for dynamically triggered CSI reports carrying time-domain beam predictions). For example, the device 805 or a component of the device 805 may include a processor 840 and memory 830 coupled with or to the processor 840, the processor 840 and memory 830 configured to perform various functions described herein.

The communications manager 820 may support wireless communications at a UE in accordance with examples as disclosed herein. For example, the communications manager 820 may be configured as or otherwise support a means for receiving a first control message indicating one or more parameter sets for beam prediction via predictive CSI reporting. The communications manager 820 may be configured as or otherwise support a means for receiving a second control message requesting the UE to transmit a CSI report indicating predicted CSI measurements based on a parameter set of the one or more parameter sets. The communications manager 820 may be configured as or otherwise support a means for transmitting, in response to the second control message, the CSI report indicating the predicted CSI measurements for a set of beams based on the parameter set.

By including or configuring the communications manager 820 in accordance with examples as described herein, the device 805 may support techniques for dynamically triggered CSI reports carrying time-domain beam predictions, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of techniques for dynamically triggered CSI reports carrying time-domain beam predictions as described herein, or the processor 840 and the memory 830 may be otherwise configured to perform or support such operations.

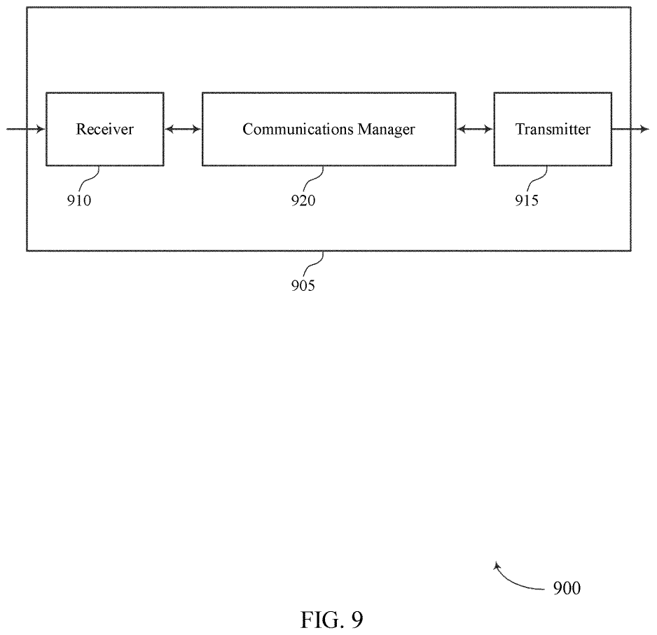

FIG. 9 shows a block diagram 900 of a device 905 that supports techniques for dynamically triggered CSI reports carrying time-domain beam predictions in accordance with one or more aspects of the present disclosure. The device 905 may be an example of aspects of a network entity 105 as described herein. The device 905 may include a receiver 910, a transmitter 915, and a communications manager 920. The device 905 may also include a processor (not shown). Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of techniques for dynamically triggered CSI reports carrying time-domain beam predictions as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity in accordance with examples as disclosed herein. For example, the communications manager 920 may be configured as or otherwise support a means for transmitting a first control message indicating one or more parameter sets for beam prediction via predictive CSI reporting. The communications manager 920 may be configured as or otherwise support a means for transmitting a second control message requesting a UE to transmit a CSI report indicating predicted CSI measurements based on a parameter set of the one or more parameter sets. The communications manager 920 may be configured as or otherwise support a means for receiving, in response to the second control message, the CSI report indicating the predicted CSI measurements for a set of beams based on the parameter set.

By including or configuring the communications manager 920 in accordance with examples as described herein, the device 905 (e.g., a processor controlling or otherwise coupled with the receiver 910, the transmitter 915, the communications manager 920, or any combination thereof) may support techniques for dynamically triggered CSI reports carrying time-domain beam predictions, which may result in reduced processing, reduced power consumption, and more efficient utilization of communication resources, among other advantages.

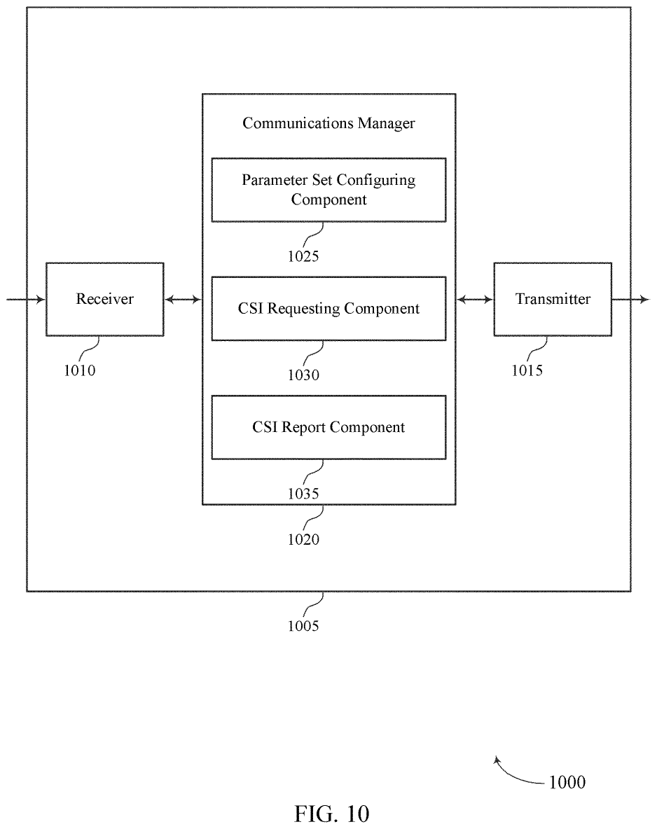

FIG. 10 shows a block diagram 1000 of a device 1005 that supports techniques for dynamically triggered CSI reports carrying time-domain beam predictions in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor (not shown). Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of techniques for dynamically triggered CSI reports carrying time-domain beam predictions as described herein. For example, the communications manager 1020 may include a parameter set configuring component 1025, a CSI requesting component 1030, a CSI report component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. The parameter set configuring component 1025 may be configured as or otherwise support a means for transmitting a first control message indicating one or more parameter sets for beam prediction via predictive CSI reporting. The CSI requesting component 1030 may be configured as or otherwise support a means for transmitting a second control message requesting a UE to transmit a CSI report indicating predicted CSI measurements based on a parameter set of the one or more parameter sets. The CSI report component 1035 may be configured as or otherwise support a means for receiving, in response to the second control message, the CSI report indicating the predicted CSI measurements for a set of beams based on the parameter set.

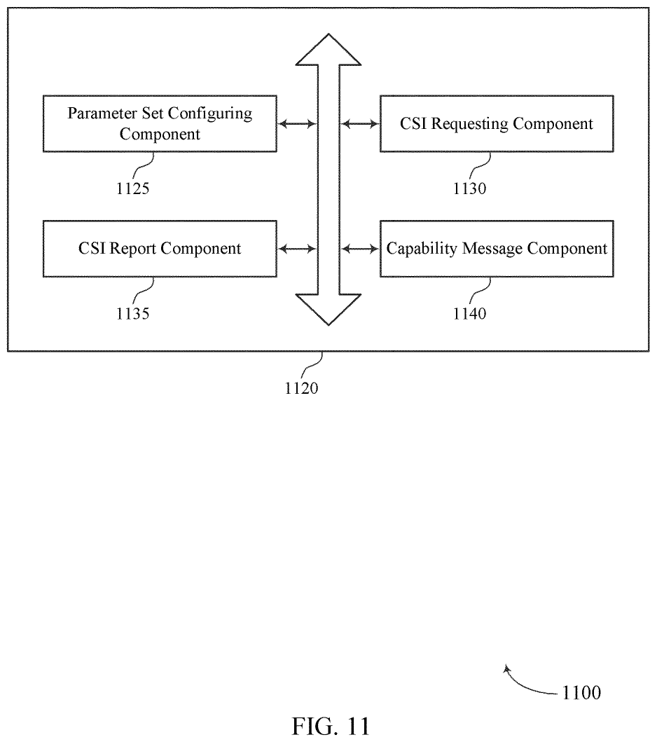

FIG. 11 shows a block diagram 1100 of a communications manager 1120 that supports techniques for dynamically triggered CSI reports carrying time-domain beam predictions in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for dynamically triggered CSI reports carrying time-domain beam predictions as described herein. For example, the communications manager 1120 may include a parameter set configuring component 1125, a CSI requesting component 1130, a CSI report component 1135, a capability message component 1140, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications at a network entity in accordance with examples as disclosed herein. The parameter set configuring component 1125 may be configured as or otherwise support a means for transmitting a first control message indicating one or more parameter sets for beam prediction via predictive CSI reporting. The CSI requesting component 1130 may be configured as or otherwise support a means for transmitting a second control message requesting a UE to transmit a CSI report indicating predicted CSI measurements based on a parameter set of the one or more parameter sets. The CSI report component 1135 may be configured as or otherwise support a means for receiving, in response to the second control message, the CSI report indicating the predicted CSI measurements for a set of beams based on the parameter set.

In some examples, the capability message component 1140 may be configured as or otherwise support a means for receiving a capability message indicating a capability of the UE for the beam prediction, where the predicted CSI measurements for the set of beams are based on the capability message.

In some examples, the capability message indicates a first supported time domain gap between a first slot where the second control message is transmitted and a starting symbol or an ending symbol for the predicted CSI measurements, a second supported time domain gap between the first slot where the second control message is transmitted and a second slot where the CSI report is received, a third supported time domain gap between a first symbol where the CSI report is received and the starting symbol for the predicted CSI measurements, or any combination thereof.

In some examples, the capability message indicates one or more values for the first supported time domain gap, the second supported time domain gap, or the third supported time domain gap, or any combination thereof.

In some examples, the capability message indicates a first capability of the UE for the beam prediction based on a first quantity of measurement resources or a first quantity of reported reference signals and a second capability of the UE for the beam prediction based on a second quantity of measurement resources or a second quantity of reported reference signals.

In some examples, to support transmitting the first control message, the parameter set configuring component 1125 may be configured as or otherwise support a means for transmitting the first control message indicating, for each parameter set of the one or more parameter sets, a time gap between the second control message and a future instance or a future window for the predicted CSI measurements for the set of beams.

In some examples, to support transmitting the first control message, the parameter set configuring component 1125 may be configured as or otherwise support a means for transmitting the first control message indicating, for each parameter set of the one or more parameter sets, a time gap between the second control message and a future transmission occasion for the predicted CSI measurements for the set of beams.

In some examples, to support receiving the CSI report, the CSI report component 1135 may be configured as or otherwise support a means for receiving the CSI report indicating a future instance or a future window for the predicted CSI measurements for the set of beams.

In some examples, the predicted CSI measurements for the set of beams correspond to a future time instance, during a future time window, or during a future scheduled transmission occasion associated with one or more channel measurement resources or one or more interference measurement resources.

In some examples, to support transmitting the second control message, the CSI requesting component 1130 may be configured as or otherwise support a means for transmitting a DCI message triggering an aperiodic CSI report based on the parameter set, where the aperiodic CSI report is the CSI report.

In some examples, to support transmitting the second control message, the CSI requesting component 1130 may be configured as or otherwise support a means for transmitting a medium access control message activating a semi-persistent CSI report based on the parameter set, where the semi-persistent CSI report is the CSI report.

In some examples, to support transmitting the first control message, the parameter set configuring component 1125 may be configured as or otherwise support a means for transmitting the first control message indicating the one or more parameter sets and a second set of parameter sets, where the one or more parameter sets are associated with CSI prediction, and the second set of parameter sets are associated with historic CSI measurements.

In some examples, to support transmitting the second control message, the CSI requesting component 1130 may be configured as or otherwise support a means for transmitting the second control message with a radio network temporary identifier associated with CSI prediction.

In some examples, a field of the second control message indicating the one or more parameter sets is associated with CSI prediction.

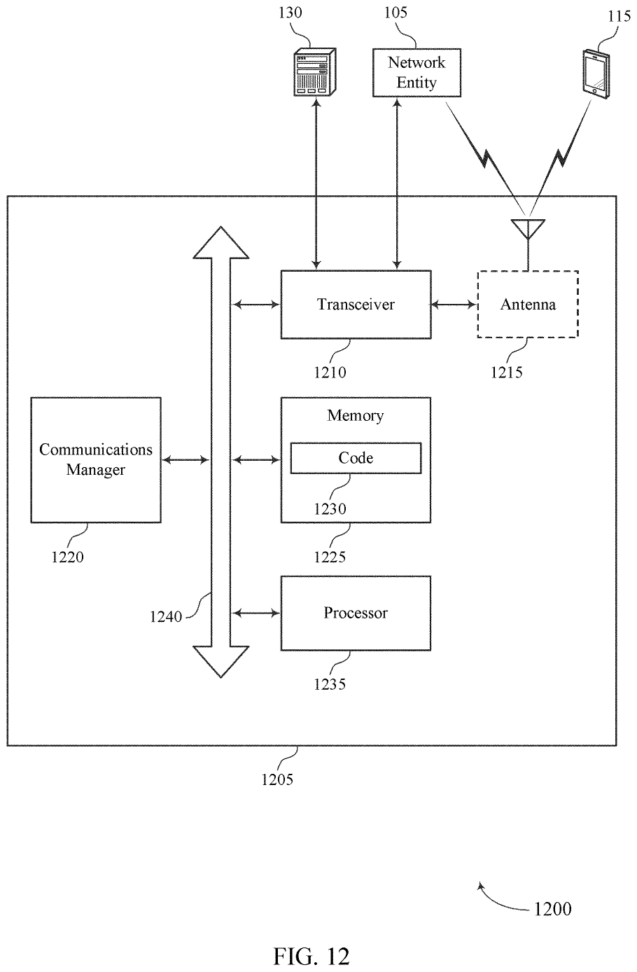

FIG. 12 shows a diagram of a system 1200 including a device 1205 that supports techniques for dynamically triggered CSI reports carrying time-domain beam predictions in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or any combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting techniques for dynamically triggered CSI reports carrying time-domain beam predictions). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications at a network entity in accordance with examples as disclosed herein. For example, the communications manager 1220 may be configured as or otherwise support a means for transmitting a first control message indicating one or more parameter sets for beam prediction via predictive CSI reporting. The communications manager 1220 may be configured as or otherwise support a means for transmitting a second control message requesting a UE to transmit a CSI report indicating predicted CSI measurements based on a parameter set of the one or more parameter sets. The communications manager 1220 may be configured as or otherwise support a means for receiving, in response to the second control message, the CSI report indicating the predicted CSI measurements for a set of beams based on the parameter set.

By including or configuring the communications manager 1220 in accordance with examples as described herein, the device 1205 may support techniques for dynamically triggered CSI reports carrying time-domain beam predictions, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of techniques for dynamically triggered CSI reports carrying time-domain beam predictions as described herein, or the processor 1235 and the memory 1225 may be otherwise configured to perform or support such operations.

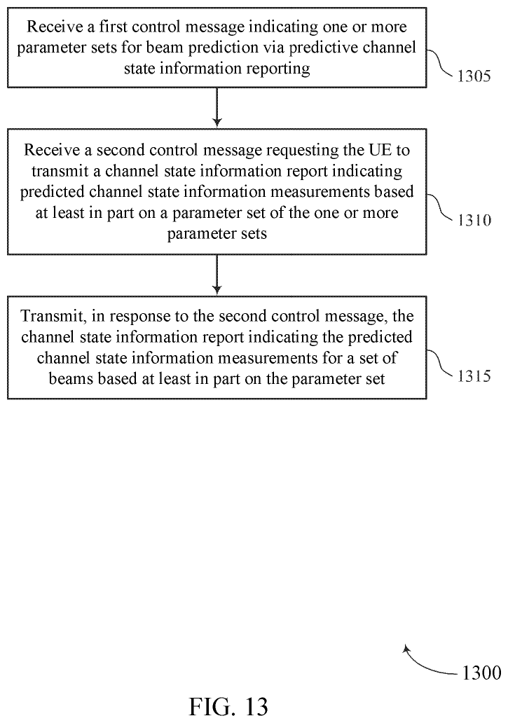

FIG. 13 shows a flowchart illustrating a method 1300 that supports techniques for dynamically triggered CSI reports carrying time-domain beam predictions in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a first control message indicating one or more parameter sets for beam prediction via predictive CSI reporting. The operations of 1305 may be performed in accordance with examples as disclosed herein. In some examples, aspects of the operations of 1305 may be performed by a parameter set configuration component 725 as described with reference to FIG. 7.

At 1310, the method may include receiving a second control message requesting the UE to transmit a CSI report indicating predicted CSI measurements based at least in part on a parameter set of the one or more parameter sets. The operations of 1310 may be performed in accordance with examples as disclosed herein. In some examples, aspects of the operations of 1310 may be performed by a CSI request component 730 as described with reference to FIG. 7.

At 1315, the method may include transmitting, in response to the second control message, the CSI report indicating the predicted CSI measurements for a set of beams based at least in part on the parameter set. The operations of 1315 may be performed in accordance with examples as disclosed herein. In some examples, aspects of the operations of 1315 may be performed by a CSI report component 735 as described with reference to FIG. 7.

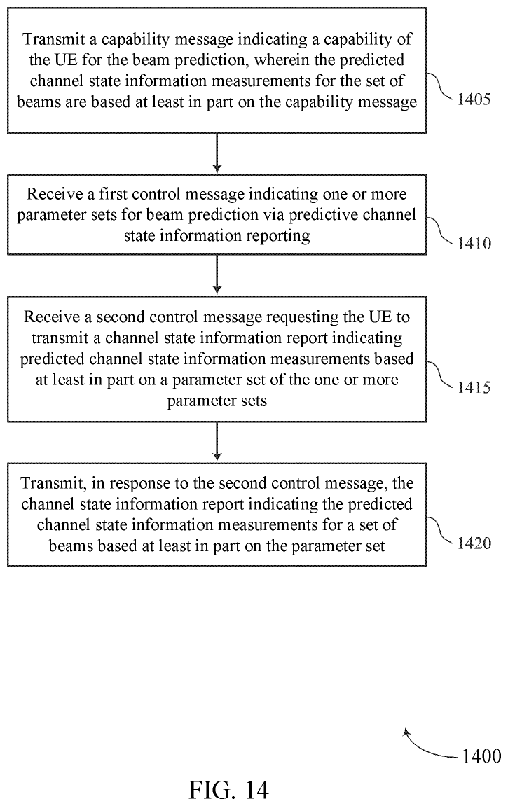

FIG. 14 shows a flowchart illustrating a method 1400 that supports techniques for dynamically triggered CSI reports carrying time-domain beam predictions in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include transmitting a capability message indicating a capability of the UE for the beam prediction, where the predicted CSI measurements for the set of beams are based at least in part on the capability message. The operations of 1405 may be performed in accordance with examples as disclosed herein. In some examples, aspects of the operations of 1405 may be performed by a capability message component 740 as described with reference to FIG. 7.

At 1410, the method may include receiving a first control message indicating one or more parameter sets for beam prediction via predictive CSI reporting. The operations of 1410 may be performed in accordance with examples as disclosed herein. In some examples, aspects of the operations of 1410 may be performed by a parameter set configuration component 725 as described with reference to FIG. 7.

At 1415, the method may include receiving a second control message requesting the UE to transmit a CSI report indicating predicted CSI measurements based at least in part on a parameter set of the one or more parameter sets. The operations of 1415 may be performed in accordance with examples as disclosed herein. In some examples, aspects of the operations of 1415 may be performed by a CSI request component 730 as described with reference to FIG. 7.

At 1420, the method may include transmitting, in response to the second control message, the CSI report indicating the predicted CSI measurements for a set of beams based at least in part on the parameter set. The operations of 1420 may be performed in accordance with examples as disclosed herein. In some examples, aspects of the operations of 1420 may be performed by a CSI report component 735 as described with reference to FIG. 7.

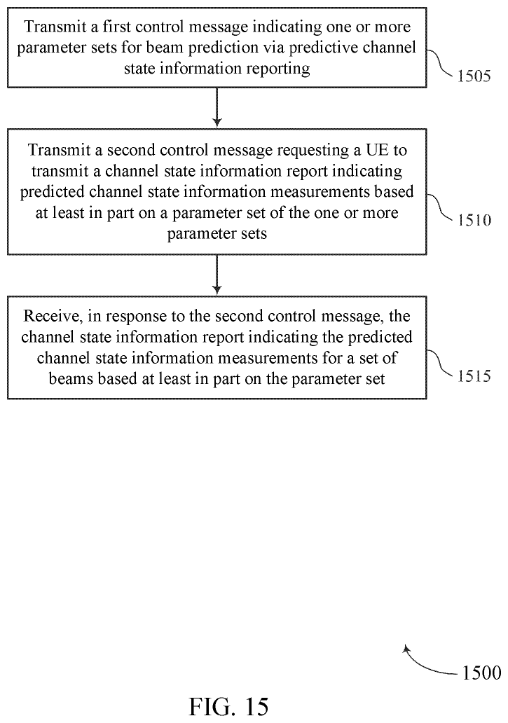

FIG. 15 shows a flowchart illustrating a method 1500 that supports techniques for dynamically triggered CSI reports carrying time-domain beam predictions in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include transmitting a first control message indicating one or more parameter sets for beam prediction via predictive CSI reporting. The operations of 1505 may be performed in accordance with examples as disclosed herein. In some examples, aspects of the operations of 1505 may be performed by a parameter set configuring component 1125 as described with reference to FIG. 11.

At 1510, the method may include transmitting a second control message requesting a UE to transmit a CSI report indicating predicted CSI measurements based at least in part on a parameter set of the one or more parameter sets. The operations of 1510 may be performed in accordance with examples as disclosed herein. In some examples, aspects of the operations of 1510 may be performed by a CSI requesting component 1130 as described with reference to FIG. 11.

At 1515, the method may include receiving, in response to the second control message, the CSI report indicating the predicted CSI measurements for a set of beams based at least in part on the parameter set. The operations of 1515 may be performed in accordance with examples as disclosed herein. In some examples, aspects of the operations of 1515 may be performed by a CSI report component 1135 as described with reference to FIG. 11.

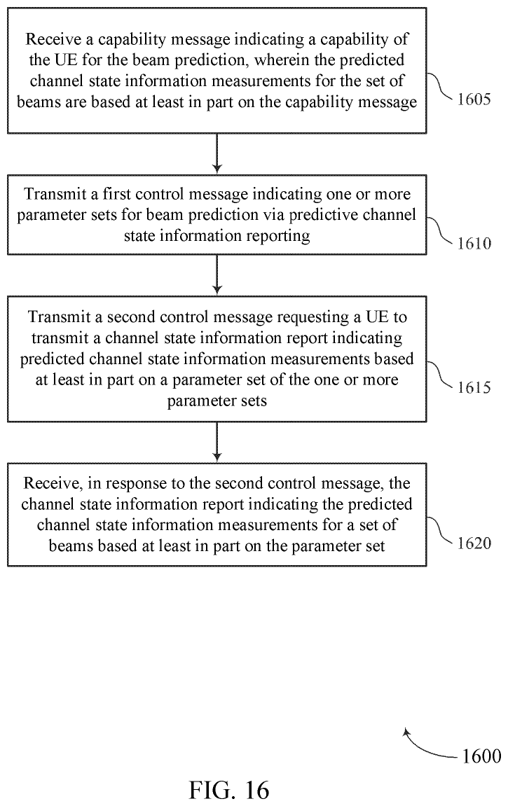

FIG. 16 shows a flowchart illustrating a method 1600 that supports techniques for dynamically triggered CSI reports carrying time-domain beam predictions in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include receiving a capability message indicating a capability of the UE for the beam prediction, where the predicted CSI measurements for the set of beams are based at least in part on the capability message. The operations of 1605 may be performed in accordance with examples as disclosed herein. In some examples, aspects of the operations of 1605 may be performed by a capability message component 1140 as described with reference to FIG. 11.

At 1610, the method may include transmitting a first control message indicating one or more parameter sets for beam prediction via predictive CSI reporting. The operations of 1610 may be performed in accordance with examples as disclosed herein. In some examples, aspects of the operations of 1610 may be performed by a parameter set configuring component 1125 as described with reference to FIG. 11.

At 1615, the method may include transmitting a second control message requesting a UE to transmit a CSI report indicating predicted CSI measurements based at least in part on a parameter set of the one or more parameter sets. The operations of 1615 may be performed in accordance with examples as disclosed herein. In some examples, aspects of the operations of 1615 may be performed by a CSI requesting component 1130 as described with reference to FIG. 11.

At 1620, the method may include receiving, in response to the second control message, the CSI report indicating the predicted CSI measurements for a set of beams based at least in part on the parameter set. The operations of 1620 may be performed in accordance with examples as disclosed herein. In some examples, aspects of the operations of 1620 may be performed by a CSI report component 1135 as described with reference to FIG. 11.

The following provides an overview of aspects of the present disclosure:

Aspect 1: A method for wireless communications at a UE, comprising: receiving a first control message indicating one or more parameter sets for beam prediction via predictive CSI reporting; receiving a second control message requesting the UE to transmit a CSI report indicating predicted CSI measurements based at least in part on a parameter set of the one or more parameter sets; and transmitting, in response to the second control message, the CSI report indicating the predicted CSI measurements for a set of beams based at least in part on the parameter set.

Aspect 2: The method of aspect 1, further comprising: transmitting a capability message indicating a capability of the UE for the beam prediction, wherein the predicted CSI measurements for the set of beams are based at least in part on the capability message.

Aspect 3: The method of aspect 2, wherein the capability message indicates a first supported time domain gap between a first slot where the second control message is received and a starting symbol or an ending symbol for the predicted CSI measurements, a second supported time domain gap between the first slot where the second control message is received and a second slot where the CSI report is transmitted, a third supported time domain gap between a first symbol where the CSI report is transmitted and the starting symbol for the predicted CSI measurements, or any combination thereof.

Aspect 4: The method of aspect 3, wherein the capability message indicates one or more values for the first supported time domain gap, the second supported time domain gap, or the third supported time domain gap, or any combination thereof.

Aspect 5: The method of any of aspects 2 through 4, wherein the capability message indicates a first capability of the UE for the beam prediction based at least in part on a first quantity of measurement resources or a first quantity of reported reference signals and a second capability of the UE for the beam prediction based at least in part on a second quantity of measurement resources or a second quantity of reported reference signals.

Aspect 6: The method of any of aspects 1 through 5, wherein receiving the first control message comprises: receiving the first control message indicating, for each parameter set of the one or more parameter sets, a time gap between the second control message and a future instance or a future window for the predicted CSI measurements for the set of beams.

Aspect 7: The method of any of aspects 1 through 6, wherein receiving the first control message comprises: receiving the first control message indicating, for each parameter set of the one or more parameter sets, a time gap between the second control message and a future transmission occasion for the predicted CSI measurements for the set of beams.

Aspect 8: The method of any of aspects 1 through 7, wherein transmitting the CSI report comprises: transmitting the CSI report indicating a future instance or a future window for the predicted CSI measurements for the set of beams.

Aspect 9: The method of any of aspects 1 through 8, further comprising: predicting CSI measurements for the set of beams at a future time instance, during a future time window, or during a future scheduled transmission occasion associated with one or more channel measurement resources or one or more interference measurement resources.

Aspect 10: The method of any of aspects 1 through 9, wherein receiving the second control message comprises: receiving a downlink control information message triggering an aperiodic CSI report based at least in part on the parameter set, wherein the aperiodic CSI report is the CSI report.

Aspect 11: The method of any of aspects 1 through 10, wherein receiving the second control message comprises: receiving a medium access control message activating a semi-persistent CSI report based at least in part on the parameter set, wherein the semi-persistent CSI report is the CSI report.

Aspect 12: The method of any of aspects 1 through 11, wherein receiving the first control message comprises: receiving the first control message indicating the one or more parameter sets and a second set of parameter sets, wherein the one or more parameter sets are associated with CSI prediction, and the second set of parameter sets are associated with historic CSI measurements.

Aspect 13: The method of any of aspects 1 through 12, wherein receiving the second control message comprises: receiving the second control message based at least in part on a radio network temporary identifier associated with CSI prediction.

Aspect 14: The method of any of aspects 1 through 13, wherein a field of the second control message indicating the one or more parameter sets is associated with CSI prediction.

Aspect 15: A method for wireless communications at a network entity, comprising: transmitting a first control message indicating one or more parameter sets for beam prediction via predictive CSI reporting; transmitting a second control message requesting a UE to transmit a CSI report indicating predicted CSI measurements based at least in part on a parameter set of the one or more parameter sets; and receiving, in response to the second control message, the CSI report indicating the predicted CSI measurements for a set of beams based at least in part on the parameter set.

Aspect 16: The method of aspect 15, further comprising: receiving a capability message indicating a capability of the UE for the beam prediction, wherein the predicted CSI measurements for the set of beams are based at least in part on the capability message.

Aspect 17: The method of aspect 16, wherein the capability message indicates a first supported time domain gap between a first slot where the second control message is transmitted and a starting symbol or an ending symbol for the predicted CSI measurements, a second supported time domain gap between the first slot where the second control message is transmitted and a second slot where the CSI report is received, a third supported time domain gap between a first symbol where the CSI report is received and the starting symbol for the predicted CSI measurements, or any combination thereof.

Aspect 18: The method of aspect 17, wherein the capability message indicates one or more values for the first supported time domain gap, the second supported time domain gap, or the third supported time domain gap, or any combination thereof.

Aspect 19: The method of any of aspects 16 through 18, wherein the capability message indicates a first capability of the UE for the beam prediction based at least in part on a first quantity of measurement resources or a first quantity of reported reference signals and a second capability of the UE for the beam prediction based at least in part on a second quantity of measurement resources or a second quantity of reported reference signals.

Aspect 20: The method of any of aspects 15 through 19, wherein transmitting the first control message comprises: transmitting the first control message indicating, for each parameter set of the one or more parameter sets, a time gap between the second control message and a future instance or a future window for the predicted CSI measurements for the set of beams.

Aspect 21: The method of any of aspects 15 through 20, wherein transmitting the first control message comprises: transmitting the first control message indicating, for each parameter set of the one or more parameter sets, a time gap between the second control message and a future transmission occasion for the predicted CSI measurements for the set of beams.

Aspect 22: The method of any of aspects 15 through 21, wherein receiving the CSI report comprises: receiving the CSI report indicating a future instance or a future window for the predicted CSI measurements for the set of beams.

Aspect 23: The method of any of aspects 15 through 22, wherein the predicted CSI measurements for the set of beams correspond to a future time instance, during a future time window, or during a future scheduled transmission occasion associated with one or more channel measurement resources or one or more interference measurement resources.

Aspect 24: The method of any of aspects 15 through 23, wherein transmitting the second control message comprises: transmitting a downlink control information message triggering an aperiodic CSI report based at least in part on the parameter set, wherein the aperiodic CSI report is the CSI report.

Aspect 25: The method of any of aspects 15 through 24, wherein transmitting the second control message comprises: transmitting a medium access control message activating a semi-persistent CSI report based at least in part on the parameter set, wherein the semi-persistent CSI report is the CSI report.

Aspect 26: The method of any of aspects 15 through 25, wherein transmitting the first control message comprises: transmitting the first control message indicating the one or more parameter sets and a second set of parameter sets, wherein the one or more parameter sets are associated with CSI prediction, and the second set of parameter sets are associated with historic CSI measurements.

Aspect 27: The method of any of aspects 15 through 26, wherein transmitting the second control message comprises: transmitting the second control message with a radio network temporary identifier associated with CSI prediction.

Aspect 28: The method of any of aspects 15 through 27, wherein a field of the second control message indicating the one or more parameter sets is associated with CSI prediction.

Aspect 29: An apparatus for wireless communications at a UE, comprising a processor; memory coupled with the processor, with instructions stored in the memory, the instructions being executable by the processor to cause the apparatus to perform a method of any of aspects 1 through 14.

Aspect 30: An apparatus for wireless communications at a UE, comprising at least one means for performing a method of any of aspects 1 through 14.

Aspect 31: A non-transitory computer-readable medium storing code for wireless communications at a UE, the code comprising instructions executable by a processor to perform a method of any of aspects 1 through 14.

Aspect 32: An apparatus for wireless communications at a network entity, comprising a processor; memory coupled with the processor, with instructions stored in the memory, the instructions being executable by the processor to cause the apparatus to perform a method of any of aspects 15 through 28.

Aspect 33: An apparatus for wireless communications at a network entity, comprising at least one means for performing a method of any of aspects 15 through 28.

Aspect 34: A non-transitory computer-readable medium storing code for wireless communications at a network entity, the code comprising instructions executable by a processor to perform a method of any of aspects 15 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communications at a user equipment (UE), comprising:
receiving a first control message indicating one or more parameter sets for beam prediction via predictive channel state information reporting;
receiving a second control message requesting the UE to transmit a channel state information report indicating predicted channel state information measurements based at least in part on a parameter set of the one or more parameter sets; and
transmitting, in response to the second control message, the channel state information report indicating the predicted channel state information measurements for a set of beams based at least in part on the parameter set.

2. The method of claim 1, further comprising:
transmitting a capability message indicating a capability of the UE for the beam prediction, wherein the predicted channel state information measurements for the set of beams are based at least in part on the capability message.

3. The method of claim 2, wherein the capability message indicates a first supported time domain gap between a first slot where the second control message is received and a starting symbol or an ending symbol for the predicted channel state information measurements, a second supported time domain gap between the first slot where the second control message is received and a second slot where the channel state information report is transmitted, a third supported time domain gap between a first symbol where the channel state information report is transmitted and the starting symbol for the predicted channel state information measurements, or any combination thereof.

4. The method of claim 3, wherein the capability message indicates one or more values for the first supported time domain gap, the second supported time domain gap, or the third supported time domain gap, or any combination thereof.

5. The method of claim 2, wherein the capability message indicates a first capability of the UE for the beam prediction based at least in part on a first quantity of measurement resources or a first quantity of reported reference signals and a second capability of the UE for the beam prediction based at least in part on a second quantity of measurement resources or a second quantity of reported reference signals.

6. The method of claim 1, wherein receiving the first control message comprises:
receiving the first control message indicating, for each parameter set of the one or more parameter sets, a time gap between the second control message and a future instance or a future window for the predicted channel state information measurements for the set of beams.

7. The method of claim 1, wherein receiving the first control message comprises:
receiving the first control message indicating, for each parameter set of the one or more parameter sets, a time gap between the second control message and a future transmission occasion for the predicted channel state information measurements for the set of beams.

8. The method of claim 1, wherein transmitting the channel state information report comprises:
transmitting the channel state information report indicating a future instance or a future window for the predicted channel state information measurements for the set of beams.

9. The method of claim 1, further comprising:
predicting channel state information measurements for the set of beams at a future time instance, during a future time window, or during a future scheduled transmission occasion associated with one or more channel measurement resources or one or more interference measurement resources.

10. The method of claim 1, wherein receiving the second control message comprises:
receiving a downlink control information message triggering an aperiodic channel state information report based at least in part on the parameter set, wherein the aperiodic channel state information report is the channel state information report.

11. The method of claim 1, wherein receiving the second control message comprises:
receiving a medium access control message activating a semi-persistent channel state information report based at least in part on the parameter set, wherein the semi-persistent channel state information report is the channel state information report.

12. The method of claim 1, wherein receiving the first control message comprises:
receiving the first control message indicating the one or more parameter sets and a second set of parameter sets, wherein the one or more parameter sets are associated with channel state information prediction, and the second set of parameter sets are associated with historic channel state information measurements.

13. The method of claim 1, wherein receiving the second control message comprises:
receiving the second control message based at least in part on a radio network temporary identifier associated with channel state information prediction.

14. The method of claim 1, wherein a field of the second control message indicating the one or more parameter sets is associated with channel state information prediction.

15. A method for wireless communications at a network entity, comprising:
transmitting a first control message indicating one or more parameter sets for beam prediction via predictive channel state information reporting;
transmitting a second control message requesting a user equipment (UE) to transmit a channel state information report indicating predicted channel state information measurements based at least in part on a parameter set of the one or more parameter sets; and
receiving, in response to the second control message, the channel state information report indicating the predicted channel state information measurements for a set of beams based at least in part on the parameter set.

16. The method of claim 15, further comprising:
receiving a capability message indicating a capability of the UE for the beam prediction, wherein the predicted channel state information measurements for the set of beams are based at least in part on the capability message.

17-19. (canceled)

20. The method of claim 15, wherein transmitting the first control message comprises:
transmitting the first control message indicating, for each parameter set of the one or more parameter sets, a time gap between the second control message and a future instance or a future window for the predicted channel state information measurements for the set of beams.

21. The method of claim 15, wherein transmitting the first control message comprises:
transmitting the first control message indicating, for each parameter set of the one or more parameter sets, a time gap between the second control message and a future transmission occasion for the predicted channel state information measurements for the set of beams.

22. The method of claim 15, wherein receiving the channel state information report comprises:
receiving the channel state information report indicating a future instance or a future window for the predicted channel state information measurements for the set of beams.

23-28. (canceled)

29. An apparatus for wireless communications at a user equipment (UE), comprising:
a processor; and
a memory coupled with the processor, with instructions stored in the memory, the instructions being executable by the processor to cause the apparatus to:
receive a first control message indicating one or more parameter sets for beam prediction via predictive channel state information reporting;
receive a second control message requesting the UE to transmit a channel state information report indicating predicted channel state information measurements based at least in part on a parameter set of the one or more parameter sets; and
transmit, in response to the second control message, the channel state information report indicating the predicted channel state information measurements for a set of beams based at least in part on the parameter set.

30. (canceled)
